(19) United States
(12) Patent Application Publication
(10) Pub. No.: US 2005/0165989 A1
(43) Pub. Date: Jul. 28, 2005

(54) I2C communication system and method enabling bi-directional communications

(76) Inventor: Yong-jae Kim, Suwon-si (KR)

Correspondence Address: STANZIONE & KIM, LLP, 1740 N STREET, N.W., FIRST FLOOR, WASHINGTON, DC, 20036, US

(21) Appl. No.: 11/028,319

(22) Filed: Jan. 4, 2005

(30) Foreign Application Priority Data
Jan. 26, 2004 (KR) 2004-4743

(51) Int. Cl. G06F 13/00

(52) U.S. Cl. 710/260

(57) ABSTRACT

A communication system and method enabling bi-directional I2C communications is disclosed. In the communication system having a master and at least one slave that communicate with each other through an I2C bus comprising a Serial Clock line (SCL) and a Serial Data line (SDA), the master and slave are directly connected on an interrupt line, and, if the slave sends to the master an interrupt requesting communications, the master performs communications with the slave through the SCL and the SDA. Therefore, the communication system and method enables slaves to generate an interrupt to request communications to the master, so bi-directional communications between microprocessors can be achieved in a simple hardware implementation.

### CROSS-REFERENCE TO RELATED APPLICATIONS

This application claims benefit under 35 U.S.C. § 119 from Korean Patent Application No. 20044743, filed on Jan. 26, 2004, the disclosure of which is incorporated herein in its entirety and by reference.

### BACKGROUND OF THE INVENTION

1. Field of the Invention

The present general inventive concept relates to an I2C communication system, and more particularly, to an I2C communication system and method enabling bi-directional communications between a slave device and a master device that are connected to each other through an I2C bus.

2. Description of the Related Art

The I2C bus is a bi-directional two-wire serial bus providing a communication link between integrated circuits (ICs) for mass-production devices such as televisions, video cassette recorders, audio equipment, and so on. The I2C bus was introduced by Philips Semiconductors, and has become the de-facto solution for embedded applications.

The I2C bus has a serial clock line (SCL) for sending clock pulses and a serial data line (SDA) for serially sending data, and sends and receives data according to clock pulses. Further, the devices connected to the I2C bus communicate as a master and a slave. The I2C protocol is a serial bus protocol capable of supporting communications with a plurality of slaves which are connected through the two lines (SCL and SDA) and power lines to send and receive data.

General systems need signal lines and power lines corresponding to the number of inputs and outputs (I/O) for enabling a microcomputer and various I/O devices to communicate therebetween. Examples of I/O devices include analog-to-digital converters (ADCs), sensors, and EEPROMs. The serial interface protocol, that is, the I2C protocol, was introduced to reduce such complicatedness. A microcomputer can now communicate with individual devices connected in common through the I2C bus.

FIG. 1 is a block diagram schematically showing a general I2C bus structure. In FIG. 1, an I2C master device 1 is connected to an I2C slave device 2 through the SCL and SDA lines. Only one slave device is shown for the convenience of explanation. The I2C master device 1 simply performs operations of writing or reading data into or out of I/O devices on the I2C bus by use of an I2C bus controller (not shown) in order to control the I/O devices supporting the I2C protocol.

Furthermore, the I2C master device 1 is a device to generate clock pulses to start and terminate data transfer, and the I2C slave device 2 is a device that the I2C master device 1 addresses. If the I2C master device 1 puts it into the start condition, the slave devices connected on the bus await data to come in.

If the I2C master device 1 sends a slave address, the individual devices compare it to their unique addresses, and a device having the same address as sent (the I2C slave device 2 in this example) sends a response to the addressing in a subsequent acknowledge (ACK) signal interval. Next, the I2C master device 1 can send and receive data to and from the I2C slave device 2. If the data is completely sent and received, the I2C master device 1 puts the slave device into the stop condition, and releases the bus.

In the prior art as described above, the I2C master device 1 performs the addressing for data reception and transmission through the I2C bus, and the I2C slave device 2 can participate in the communications in response to only the requests by the I2C master device 1 for data reception and transmission. Thus, there is a problem in that the I2C slave device 2 cannot request data reception and transmission.

In particular, if the I2C slave device 2 is a processor for controlling other devices, and if it is necessary to notify the I2C master device 1 of various situations occurring in the other devices, there is no way for the I2C slave 2 to notify the I2C master 1 of such situations.

### SUMMARY OF THE INVENTION

The present general inventive concept has been developed in order to solve the above drawbacks and other problems associated with the conventional arrangement. Accordingly, the present general inventive concept provides an I2C communication system capable of carrying out bi-directional communications wherein a slave device (or slave) connected on an I2C bus generates an interrupt signal (or interrupt) to request communications and sends that interrupt to a master device (or master) if the slave needs to communicate with the master.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept may be achieved by providing a bi-directional I2C communication system having a master and at least one slave that communicate with each other through an I2C bus including a Serial Clock line (SCL) and a Serial Data line (SDA), wherein the master and slave are directly connected on an interrupt line, and, if the slave sends to the master an interrupt to request communications, the master performs communications with the slave through the SCL and the SDA.

The interrupt line may connect the slave to a parallel interface of the master.

Further, the slave may comprise an interrupt generator to generate the interrupt to request communications through the interrupt line directly connected to the master, an SDA part to send and receive data through the SDA according to clock pulses sent through the SCL from the master having received the interrupt, and a data processor to process data into a transmission format to be sent and received through the SDA.

The data processor may process data into a packet having a payload including at least one byte.

The data may be packetized and continuously sent and received in packet form through the SDA, and, if one packet is completely sent and received, the communications are terminated.

The data may also be sent and received in byte form through the SDA. If one byte is completely sent and received, the communication is terminated.

The master may comprise an interrupt detector to detect whether the interrupt to request communications is received from the slave, an SCL part to generate and send clock pulses through the SCL to communicate with the slave, and a controller to, if the controller receives from the interrupt detector a detection signal to notify of interrupt detection (the slave having sent the interrupt), send clock pulses to the slave through the SCL, and to send an address of the slave through the SDA to start sending and receiving data.

The foregoing and/or other aspects and advantages of the present general inventive concept are also substantially realized by providing a bi-directional I2C communication method of communications between a master and at least one slave through an I2C bus including a Serial Clock line (SCL) and a Serial Data line (SDA), the method comprising sending from the slave an interrupt to request communications through an interrupt line directly connected to the master, and to perform communications between the master and the slave through the SCL and the SDA, if the master receives the interrupt. The interrupt line may connect the slave to a parallel interface of the master.

Further, the operation of performing communications may include sending and receiving data through the SDA according to the clock pulses sent through the SCL from the master, and processing the data received through the SDA.

The data may be packetized to comprise a payload including at least one byte. The data may be packetized and continuously sent and received in packet form through the SDA. If one packet is completely sent and received, the communications are terminated.

The data may also be sent and received in byte form through the SDA, and, if one byte is completely sent and received, the communication is terminated.

The operation of performing communications may further include generating a detection signal notifying of interrupt detection (the slave having sent the interrupt), if the interrupt to request communications is received from the slave, generating and sending clock pulses to communicate with the slave, and if the detection signal occurs, sending an address of the slave through the SDA to start the sending and receiving of the data, and calculating a checksum included in the data to check errors, after the data is completely sent and received.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a block diagram schematically showing an I2C bus structure;

FIG. 2 is a schematic representation of a basic structure of a bi-directional I2C bus according to an embodiment of the present general inventive concept;

FIG. 3 is a schematic representation of an I2C communication system according to an embodiment of the present general inventive concept;

FIGS. 4A and 4B are schematic representations of data to be sent and received in the I2C communication system according to an embodiment of the present general inventive concept; and

FIG. 5 is a flow chart explaining the operations of an I2C communication system according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

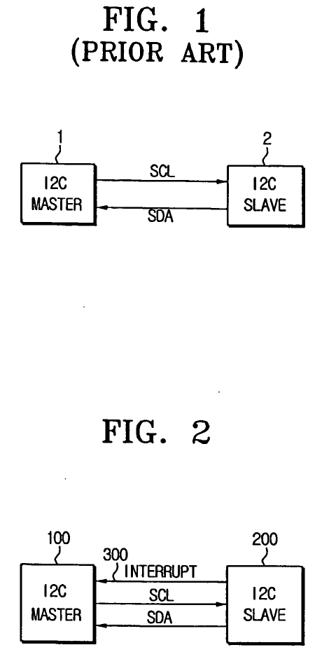

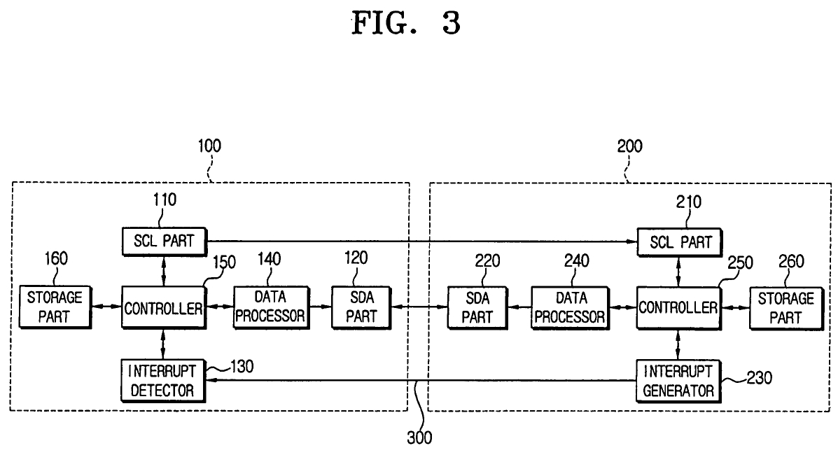

FIG. 2 is a schematic representation of a basic structure of a bi-directional I2C (I²C) bus according to an embodiment of the present general inventive concept. In FIG. 2, an I2C master device (or master) 100 is connected to an I2C slave device (or slave) 200 by an interrupt line 300 and the two lines (serial clock line (SCL) and serial data line (SDA) of the I2C bus. The I2C master 100 corresponds to a microcomputer or the like, for example, and addresses the I2C slave 200 through the I2C bus, generates clock pulses, and sends and receives data. Further, the I2C slave 200 corresponds to a device having a built-in communication interface, such as a microprocessor to control other devices in a wired or wireless manner.

The interrupt line 300 forms one signal line, which is implemented by using one of a set of pins provided on a general-purpose I/O (GPIO) port being a parallel interface. That is, the interrupt line 300 is formed in a simple structure in that the pins of the GPIO interface (not shown) provided on the I2C master 100 are assigned and connected, one by one, to individual slaves. Thus, the interrupt signal (or interrupt) sent from the I2C slave 200 is applied to the GPIO interface (not shown) of the I2C master 100 through the interrupt line 300 in order to request communications with the I2C master 100.

FIG. 3 is a schematic representation of an I2C communication system according to an embodiment of the present general inventive concept. In FIG. 3, the I2C master 100 has an SCL part 110, an SDA part 120, an interrupt detector 130, a data processor 140, a controller 150, and a storage part 160.

The SCL part 110 generates an operation frequency of the I2C slave 200, and generates clock pulses and transmits them to the I2C slave 200 through the SCL line. The SDA part 120 sends a slave address through the SDA line to address the I2C slave 200, and, if communications begin, sends and receives data to and from the I2C slave 200 through the SDA line.

The data processor 140 generates data to be sent to the I2C slave 200 according to a format set in advance, and/or processes data received from the I2C slave 200. The structure of data to be sent or received between the I2C master 100 and the I2C slave 200 will be described later.

The controller 150 monitors the state of the I2C bus, controls the SCL part 110 and the SDA part 120 to generate an initial condition, sends and receives data to and from the I2C slave 200 or generates a termination condition, and terminates the data reception and transmission. Further, if the interrupt detector 130 detects an interrupt by the I2C slave 200, the controller 150 controls the SCL part 110, the SDA part 120 and the data processor 140 to communicate with the I2C slave 200.

The storage part 160 stores various data, programs, and protocols necessary to the operations of the controller 150, and various data occurring during the operations of the controller 150. Further, the storage part 160 stores various data necessary to the operations of the SCL part 110, SDA part 120, and data processor 140, and stores data processed by the data processor 140.

The interrupt detector 130 detects interrupt signals received from the I2C slave 200 through the interrupt line 300, and outputs to the controller 150 a detection signal including information on the I2C slave 200 having sent the interrupt. The interrupt detector 130 is connected to the interrupt line 300 through the above parallel interface (not shown), so the interrupt detector 130 can detect the I2C slave 200 generating the interrupt based on the pin at which the interrupt is detected.

In FIG. 3, the I2C slave 200 has an SCL part 210, an SDA part 220, an interrupt generator 230, a data processor 240, a controller 250, and a storage part 260.

The SCL part 210 receives clock pulses from the I2C master 100 through the SCL line. The SDA part 220 receives the slave address through the SDA line connected to the I2C master 100, and, if communications begin, sends and receives data to and from the I2C master 100 according to the clock pulses received through the SCL line.

The data processor 240 generates data to be sent to the I2C master 100 according to a format set in advance, and/or processes data received from the I2C master 100.

The controller 250 monitors the state of the I2C bus, and, if communications start, controls the SDA part 220 to send and receive data to and from the I2C master 100. Further, the controller 250 controls the interrupt generator 230 to generate an interrupt signal to request communications, if necessary to communicate with the I2C master 100. The interrupt generated by the interrupt generator 230 is sent to the I2C master 100 through the parallel interface (not shown) and the interrupt line 300.

The operation of the storage part 260 is the same as that of the storage part 160 of the I2C master 100, so a detailed description on the storage part 260 will be omitted.

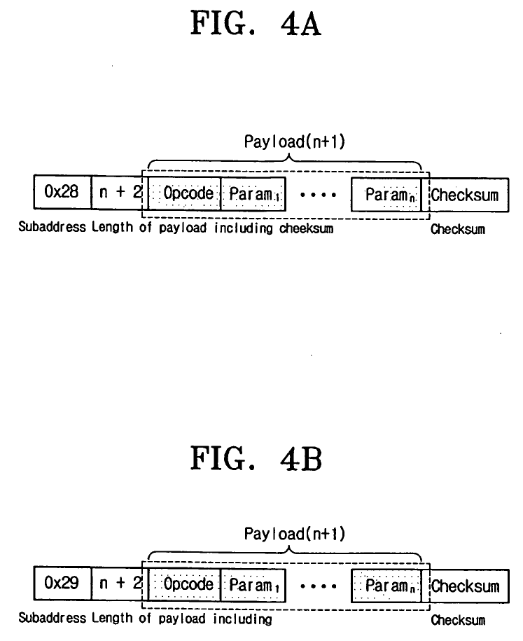

FIGS. 4A and 4B are schematic representations of data to be sent and received in the I2C communication system according to an embodiment of the present general inventive concept. FIG. 4A shows a packet to be sent from the I2C master 100 to the I2C slave 200, in which the first byte corresponds to an address and the next byte indicates a length of the payload including a checksum. The operational code (or Opcode) follows and includes an ID to distinguish data. Data following the Opcode takes up 1 to N bytes, and is followed by a checksum. FIG. 4B shows a packet to be sent from the I2C slave 200 to the I2C master 100, and the format is the same as in FIG. 4A, except for the first byte indicating an address.

The data format of communications between the I2C master 100 and the I2C slave 200 complies with the general I2C protocol. However, the data transfer method according to the present general inventive concept enables communications to be achieved in packets, which will be described later in detail.

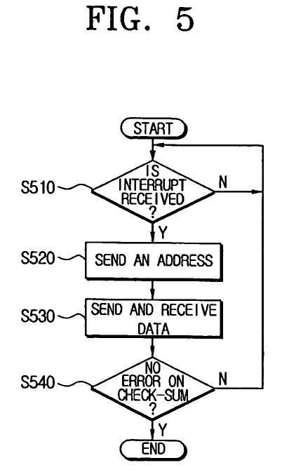

FIG. 5 is a flow chart explaining the operations of an I2C communication system according to an embodiment of the present general inventive concept. Description will be made in detail on the operations of the I2C bus controller according to an embodiment of the present general inventive concept, with reference to FIG. 5.

The I2C master 100 starts communications with the I2C slave 200, and sends and receives data through the I2C bus. This particular process is the same as in the prior art and well known to those skilled in the art, so a detailed description on the process will be omitted.

The I2C slave 200 corresponds to a processor. The I2C slave 200 notifies the I2C master 100 of its state and/or the states of its subordinate devices, and, if the I2C slave 200 needs operations of the I2C master 100 corresponding to these states, the I2C slave 200 generates an interrupt to request the communications with the I2C master 100. The interrupt is generated by the interrupt generator 230 of the I2C slave 200, and sent to the I2C master 100 through the interrupt line 300.

A determination is made by the controller 150 of the I2C master 100 as to whether the interrupt detector 130 received an interrupt (Operation S510). If the interrupt detector 130 detects an interrupt, the interrupt detector 130 sends to the controller 150 a detection signal notifying of the interrupt detection and the I2C slave 200 that issued the interrupt.

The controller 150 controls the SCL part 110 and the SDA part 120 to generate an operation frequency of the I2C slave 200 that generated the interrupt, generates and sends clock pulses to the I2C slave 200 through the SCL line, and sends the address of the I2C slave 200 through the SDA line (Operation S520).

Upon the termination of the addressing, data is sent and received between the SDA part 120 of the I2C master 100 and the SDA part 220 of the I2C slave 200 through the SDA line (Operation S530).

The I2C slave 200 may send and receive data either in packet form or in byte form. If the I2C slave 200 sends and receives data in packets, the I2C master 100 receives data from the I2C slave 200 according to the I2C read format after a communication request by an interrupt of the I2C slave 200 and addressing. The I2C master 100 terminates the data communications after reading all the packets up to the last byte. In this mode, a packet is continuously sent through the SDA line from the address byte and the byte indicating the packet length up to the last checksum as shown in FIG. 4B. Thus, the SDA line is exclusively assigned to communications between the I2C slave 200 and the I2C master 100 until each packet is completely sent and received. When the I2C slave 200 needs to send another packet, the I2C slave 200 produces another interrupt to request communications with the I2C master 100, and the I2C master 100 performs addressing of the communications.

If the data is sent and received in byte form, the communications between the I2C. master 100 and the I2C slave 200 commence with a request by the interrupt of the I2C slave 200 and are terminated when all the bytes are sent. Thus, if there are remaining bytes to be sent after one byte has been completely sent, the I2C slave 200 generates another interrupt to request communications to the I2C master 100. Accordingly, the interrupt has to occur with every byte transmission. This may be desirable because the SDA line of the I2C bus is not exclusively occupied, so the SDA line can be assigned to communications with other slaves during the time between the intervals for the byte transmissions. Thus, the I2C master 100 can perform other operations in parallel in addition to the communications with the I2C slave 200.

The data processor 140 processes data received from the I2C slave 200. If the data is sent in packet form, the data processor 140 counts the checksum bytes of the received packets to detect whether the received packets have errors. If the packets have no errors, the data processor 140 performs its operations according to the processed data. If the data is sent in byte form, the data processor 140 combines received bytes in order to calculate the checksum, and performs the operations according to the processed data. Therefore, the present general inventive concept enables communications from an I2C slave 200 to an I2C master 100 as well as communications from the I2C master 100 to the I2C slave 200, resulting in bi-directional communications in a simple hardware implementation.

The I2C communication system capable of bi-directional communications according to the present general inventive concept enables slave devices to generate interrupts to request communications with the master device, so bi-directional communications between microprocessors can be achieved in a simple hardware implementation.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A bi-directional I2C communication system comprising:
a master device; and
at least one slave device communicably connected with the master device through an I2C bus comprising:
a serial clock line; and
a serial data line;
wherein the master device and the slave device are directly connected on an interrupt line, and wherein, if the slave device sends to the master device an interrupt signal to request communications, the master device communicates with the slave device through the serial clock line and the serial data line.

2. The bi-directional I2C communication system as claimed in claim 1, wherein the interrupt line connects the slave device to a parallel interface of the master device.

3. The bi-directional I2C communication system as claimed in claim 1, wherein the slave device comprises:
an interrupt generator to generate the interrupt signal to request communications through the interrupt line directly connected to the master device;
a serial data line part to send and receive data through the serial data line according to clock pulses sent through the serial clock line from the master device having received the interrupt signal; and
a data processor to process data into a transmission format to be sent and received through the serial data line.

4. The bi-directional I2C communication system as claimed in claim 3, wherein the data processor processes data into a packet comprising a payload comprising one byte.

5. The bi-directional I2C communication system as claimed in claim 3, wherein the data is packetized, and continuously sent and received in packet form through the serial data line, and, if one packet is completely sent and received, the communications are terminated.

6. The bi-directional I2C communication system as claimed in claim 3, wherein the data is sent and received in byte form through the serial data line, and, if one byte is completely sent and received, the communication is terminated.

7. The bi-directional I2C communication system as claimed in claim 3, wherein the slave device further comprises:
a serial clock line part to receive clock pulses received through the serial clock line from the master device.

8. The bi-directional I2C communication system as claimed in claim 3, wherein the slave device further comprises:
a controller to monitor the state of the I2C bus, and to control the serial data line part to send and receive data through the serial data line, and to control the interrupt generator to generate the interrupt signal to request communications through the interrupt line directly connected to the master device.

9. The bi-directional I2C communication system as claimed in claim 1, wherein the master device comprises:
an interrupt detector to detect whether the interrupt signal requesting communications is received from the slave device;
a serial clock line part to generate and send clock pulses through the serial clock line to communicate with the slave device; and
a controller to, if the controller receives from the interrupt detector a detection signal notifying of interrupt detection and of the slave device that sent the interrupt signal, send clock pulses to the slave device through the serial clock line and to send an address of the slave device through the serial data line to start sending and receiving data.

10. The bi-directional I2C communication system as claimed in claim 9, wherein the master device further comprises:
a serial data line part to send the address of the slave device through the serial data line to start sending and receiving data, and to send and receive data to and from the slave device through the serial data line.

11. A bi-directional I2C communication system including a master device and at least one slave device communicating data with the master device, comprising:
a serial clock line to communicate clock pulses between the master device and the slave device;
a serial data line to communicate data between the master device and the slave device; and
an interrupt line to communicate interrupt requests to the master device from the slave device.

12. The bi-directional I2C communication system as claimed in claim 11, wherein the interrupt line is adapted to be connected to a parallel interface of a master device.

13. A bi-directional I2C communication system comprising:
a serial clock line and a serial data line combination to communicate clock signals and data, respectively;
at least one slave device that transmits a request signal requesting communication through the serial clock line and serial data line; and
a master device that receives the transmitted request signal and begins the communication with the at least one slave device requesting the communication.

14. The bi-directional I2C communication system as claimed in claim 13, further comprising an interrupt line to transmit the request signal from the slave device to the master device.

15. The bi-directional I2C communication system as claimed in claim 14, wherein the master device comprises:
a plurality of pins each assigned to one of the devices through the respective interrupt line to receive the respective request signal.

16. The bi-directional I2C communication system as claimed in claim 15, wherein the master device further comprises:
an interrupt detector to detect the request signals received from he at least one slave device at the respective pin; and
a controller to control the communications with the at least one slave device based on the detected request signals.

17. A bi-directional I2C communications system comprising:
a master device; and
at least one slave device to initiate communications with the master device via an interrupt request.

18. A bi-directional I2C communication method between a master device and at least one slave device through an I2C bus comprising a serial clock line and a serial data line, the method comprising:
sending from the slave device an interrupt signal to request communications through an interrupt line directly connected to the master device; and
performing the communications between the master device and the slave device through the serial clock line and the serial data line, if the master device receives the interrupt signal.

19. The bi-directional I2C communication method as claimed in claim 18, wherein the interrupt line connects the slave device to a parallel interface of the master device.

20. The bi-directional I2C communication method as claimed in claim 18, wherein the operation of performing communications includes:
sending, by the slave device, data through the serial data line according to the clock pulses sent through the serial clock line from the master device; and
processing, by the master device, the data received through the serial data line from the slave device.

21. The bi-directional I2C communication method as claimed in claim 20, wherein the data is packetized into a packet that comprises a payload comprising at least one byte.

22. The bi-directional I2C communication method as claimed in claim 20, wherein the data is packetized, and continuously sent and received in packet form through the serial data line, and, if one packet is completely sent and received, the communications are terminated.

23. The bi-directional I2C communication method as claimed in claim 20, wherein the data is sent and received in byte form through the serial data line, and, if one byte is completely sent and received, the communication is terminated.

24. The bi-directional I2C communication method as claimed in claim 23, further comprising:
sending from at least a second slave device an interrupt signal to request communications through an interrupt line directly connected to the master device; and
performing the communications between the master device and the at least one second slave device through the serial clock line and the serial data line, if the master device receives the interrupt signal.

25. The bi-directional I2C communication method as claimed in claim 18, wherein the operation of performing communications comprises:
generating a detection signal notifying of interrupt detection and of the slave device that sent the interrupt, if the interrupt signal requesting communications is received from the slave device;
generating and sending clock pulses to communicate with the slave device, after the detection signal is generated;
sending an address of the slave device through the serial data line to start the sending and receiving of data; and
calculating a checksum to be included with the data to check errors after the data is completely sent and received.

26. The bi-directional I2C communication method as claimed in claim 25, wherein the operation of generating a detection signal notifying of the slave device that sent the interrupt comprises:
determining the slave that sent the interrupt based on an identification of a pin of a parallel interface.

27. A method of requesting communications with a master device through an I2C bus, the method comprising:
transmitting an interrupt signal to request communications with the master device;
receiving clock pulses from the master device through an I2C bus in response to the transmitted interrupt signal;
communicating data to the master device according the received clock pulses through the I2C bus.

28. The method of requesting communications according to claim 27, wherein the interrupt signal is transmitted to the master device via an interrupt line provided by the I2C bus.

29. The method of requesting communications according to claim 27, wherein the interrupt signal is transmitted to the master device via an interrupt line connected directly to a parallel interface of the master device.

30. The method of requesting communications according to claim 27, further comprising:
packetizing data into a packet comprising a payload comprising one byte.

31. The method of requesting communications according to claim 30, wherein the operation of communicating data comprises:
sending the packet to the master device; and
terminating communications after a predetermined number of packets are sent to the master device.

32. The method of requesting communications according to claim 27, wherein the data is communicated in byte form, and wherein communications are terminated after a predetermined number of bytes are sent to the master device.
